(19) United States
(12) Patent Application Publication
(10) Pub. No.: US 2021/0331277 A1
(43) Pub. Date: Oct. 28, 2021

(54) METHODS AND SYSTEM FOR LASER-PROCESSING A METAL WORKPIECE

(71) Applicant: LASERAX INC., Québec (CA)

(72) Inventors: Alex FRASER, Québec (CA); Jean-Michaël DESCHENES, Lévis (CA); Quentin PERRY AUGER, Gatineau (CA)

(21) Appl. No.: 17/238,828

(22) Filed: Apr. 23, 2021

Related U.S. Application Data
(60) Provisional application No. 63/014,967, filed on Apr. 24, 2020.

(51) Int. Cl. B23K 26/36; B23K 26/0622; B23K 26/082; B23K 26/03; B23K 26/06; C21D 1/09

(52) U.S. Cl. CPC B23K 26/36; B23K 26/0622; B23K 26/082; C21D 6/005; B23K 26/0648; C21D 1/09; B23K 26/034

(57) ABSTRACT

There is described a method of laser-processing a metal workpiece. The method generally has a step of laser-hardening a portion of the metal workpiece by momentarily exposing said portion to an out-of-focus region of a pulsed laser beam, the exposed portion heating to a given temperature and quenching thereafter, the sequence of said heating and said quenching thereby hardening said exposed portion, and a step of laser-cleaning the hardened portion by momentarily exposing said hardened portion to an in-focus region of said pulsed laser beam, thereby cleaning said hardened portion.

### FIELD

The improvements generally relate to laser-processing a metal workpiece and more particularly relate to laser-hardening the metal workpiece.

### BACKGROUND

Manufacture of metal workpieces such as tools along a manufacturing line can require a hardening process to harden portions of the metal workpieces. Typically, the hardening process includes an initial step of heating the metal workpieces to a desired temperature, and then a subsequent step of quenching the heated metal workpieces, i.e., swiftly cooling down the heated metal workpieces. If done right, the quenched metal workpieces undergo a martensitic transformation, thereby increasing the hardness and brittleness of the metal workpieces.

In some manufacturing lines, the heating is performed by generating eddy currents within the metal workpiece via induction whereas the quenching is performed by rapidly immersing the heated metal workpieces in some sort of cold quenching substance. In some other manufacturing lines, the heating is performed by delivering a continuous wave (CW) laser beam to a localized portion of the metal workpiece whereas the quenching is performed by a surrounding, unheated portion of the metal workpiece which, as soon as the CW laser beam is removed, rapidly cools the localized heated portion thanks to its thermal inertia.

As useful as they can be, such hardening processes can have some drawbacks. For instance, regardless of how the metal workpieces are heated, undesirable residue (e.g., oxidation residue) tends to appear on the surface of metal workpiece after the heating step. Moreover, when a quenching substance is used in the quenching step, any excess thereof has to be cleaned as well. It is known to clean the quenchant excess and/or undesirable residue using shotblasting in some situations. Although existing hardening processes are satisfactory to a certain degree, there remains room for improvement, especially in the subsequent cleaning step.

### SUMMARY

As discussed above, manufacturing lines using induction-based hardening can have a heating station, a quenching station, and a shotblasting station to remove any quenchant excess and the undesirable residue off the surface of the hardened metal workpieces.

It was found that there is a need in the industry for manufacturing lines in which the hardening and cleaning steps can be performed within a single station, and preferably using the same equipment. Such a hardening and cleaning station would expedite the hardening and cleaning steps as it would reduce the delays in moving the metal workpieces from the hardening station to the cleaning station. The footprint of the resulting manufacturing lines would also be reduced by eliminating at least a station.

Unfortunately, off-the-shelf laser-based systems are typically designed for unique applications. For instance, as laser-hardening requires a laser beam which is powerful enough to heat the metal workpiece to the desired temperature, the laser beam cannot have too much peak power as heating the metal workpiece beyond the melting point of the metal would be highly unwelcome. Accordingly, CW laser sources are typically used for laser-hardening purposes.

In contrast, laser-cleaning requires an intense laser beam with high peak power so as to deliver high intensity onto the residue and/or the surface of the metal workpiece in order to ablate it, while minimizing the absorbed heat in the metal workpiece. To this end, high-power pulsed laser beam sources are preferred in laser-cleaning applications.

In an aspect of the present disclosure, there are described systems and methods which reconcile laser-hardening and laser-cleaning within a single station, thereby meeting a long felt need in the industry. More specifically, the proposed systems and methods involve the use of a high-power pulsed laser beam which is used in an out-of-focus region thereof to perform the laser-hardening, and then used in an in-focus region of the same high-power pulsed laser beam to perform the laser-cleaning. It is noted that the out-of-focus region can be defined as the region of the pulsed laser beam along which optical pulses of the pulsed laser beam have an intensity below a melting intensity threshold of the metal. In this region, the laser energy is primarily used to heat the metal workpiece. On the other hand, the in-focus region can be defined as the region of the pulsed laser beam along which optical pulses of the pulsed laser beam have an intensity equal to or greater than an ablation intensity threshold of the residue or of the metal workpiece. The ablation intensity threshold can be indicative of the intensity required to ablate the undesirable residue lying on the hardened metal workpiece or a portion of the metal workpiece itself. Accordingly, lower intensity optical pulses of a pulsed laser source are used to heat but not melt the metal workpiece in the hardening step whereas higher intensity optical pulses of the same pulsed laser source are used to sublimate the undesirable residue in a subsequent cleaning step.

In other embodiments, the metal workpiece is first moved within the out-of-focus region of the stationary pulsed laser beam to perform the laser-hardening and then moved within the in-focus region of the stationary pulsed laser beam to perform the laser-cleaning. In some other embodiments, the workpiece is stationary in which case the out-of-focus and in-focus regions of the pulsed laser beam are moved relative to the stationary metal workpiece to first perform the laser-hardening and then the laser-cleaning.

In accordance with a first aspect of the present disclosure, there is provided a method of laser-processing a metal workpiece, the method comprising: laser-hardening a portion of the metal workpiece by momentarily exposing said portion to an out-of-focus region of a pulsed laser beam, the exposed portion heating to a given temperature and quenching thereafter, the sequence of said heating and said quenching thereby hardening said exposed portion; and laser-cleaning the hardened portion by momentarily exposing said hardened portion to an in-focus region of said pulsed laser beam, thereby cleaning said hardened portion.

In accordance with a second aspect of the present disclosure, there is provided a system for laser-processing a metal workpiece along a manufacturing line, the system comprising: a hardening and cleaning station having a frame located proximate said manufacturing line where said metal workpiece is conveyed; a laser-processing unit mounted to said frame and emitting a pulsed laser beam; and a controller communicatively coupled to the laser-processing unit, the controller having a processor and a memory having stored thereon instructions that when executed by the processor perform the steps of: laser-hardening a portion of the metal workpiece by momentarily exposing said portion to an out-of-focus region of a pulsed laser beam, the exposed portion heating to a given temperature and quenching thereafter, the sequence of said heating and said quenching thereby hardening said exposed portion; and laser-cleaning the hardened portion by momentarily exposing said hardened portion to an in-focus region of said pulsed laser beam, thereby cleaning said hardened portion.

Many further features and combinations thereof concerning the present improvements will appear to those skilled in the art following a reading of the instant disclosure.

### DESCRIPTION OF THE FIGURES

In the figures,

FIG. 1 is a schematic view of an example of a system for laser-processing a metal workpiece, incorporating a controller and a laser-processing unit emitting a pulsed laser beam, in accordance with one or more embodiments;

FIG. 2 is a graph showing intensity and beam diameter as function of beam position offset from a focal point of the pulsed laser beam of FIG. 1, showing out-of-focus and in-focus regions thereof, in accordance with one or more embodiments;

FIG. 3 is a flow chart of a method of laser-processing a metal workpiece using the system of FIG. 1, in accordance with one or more embodiments;

FIG. 4A is a schematic view of the system of FIG. 1 as it laser-hardens a portion of the metal workpiece, in accordance with one or more embodiments;

FIG. 4B is a schematic view of the system of FIG. 1 as it laser-cleans the hardened portion of the metal workpiece of FIG. 4A, in accordance with one or more embodiments;

FIG. 5A is an oblique view of an example of a laser-hardening path of the pulsed laser beam of FIG. 4A, showing the pulsed laser beam being moved in back-and-forth sequences along a same transversal portion of the metal workpiece, in accordance with one or more embodiments;

FIG. 5B is an oblique view of an example of a laser-hardening path of the pulsed laser beam of FIG. 4A, showing the pulsed laser beam being moved in an arbitrary path along the metal workpiece, in accordance with one or more embodiments;

FIG. 5C is an oblique view of an example of a laser-hardening path of the pulsed laser beam of FIG. 4A, showing the pulsed laser beam being moved in transversal back-and-forth sequences while being moved longitudinally to perform a laser-hardening pass on the metal workpiece, in accordance with one or more embodiments;

FIG. 5D is top plan view of an example of a laser-hardening path of the pulsed laser beam of FIG. 4A, showing the pulsed laser beam performing laser-hardening passes alongside each other, in accordance with one or more embodiments;

FIG. 5E is a top plan view of a laser-cleaning path of the pulsed laser beam of FIG. 4B, in accordance with one or more embodiments;

FIG. 5F is an oblique view of an example of a laser-cleaning path of the pulsed laser beam of FIG. 4B, showing the pulsed laser beam being moved in transversal back-and-forth sequences while being moved longitudinally to perform a laser-cleaning pass on the metal workpiece, in accordance with one or more embodiments;

FIG. 6 is a schematic view of another example of a system for laser-processing a metal workpiece, showing a robot arm moving the metal workpiece between the steps of laser-hardening and laser-cleaning, in accordance with one or more embodiments;

FIG. 7 is a schematic view of another example of a system for laser-processing a metal workpiece, showing a moving pulsed laser beam successively performing the steps of laser-hardening and laser-cleaning, in accordance with one or more embodiments; and

FIG. 8 is a schematic view of an example of a computing device of the controller of the systems of FIGS. 1, 6 and 7, in accordance with one or more embodiments.

### DETAILED DESCRIPTION

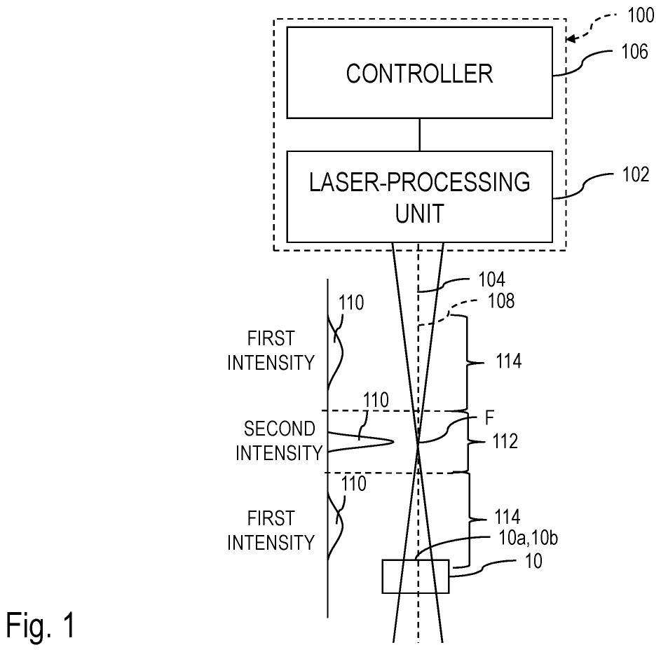

FIG. 1 shows an example of a system 100 for laser-processing a metal workpiece 10. The metal workpiece 10 can be any type of metal workpiece. Examples of metal workpieces include, but not limited to, tools (e.g., pliers, screwdrivers, cutters, knives, cutting tools), bulk pieces, plates, pipes, moulding (e.g., extrusion) dies and the like. The metal workpiece 10 can be made of any laser-processable type of metal including, but not limited to, carbon, alloys, and steels such as tool steels. In some embodiments, the system 100 can be positioned along a manufacturing line for laser-processing metal workpieces such as metal workpiece 10 in series, examples of which will be described further below.

As depicted, the system 100 includes a laser-processing unit 102 which emits a pulsed laser beam 104, and a controller 106 which is communicatively coupled to the laser-processing unit 102. The pulsed laser beam 104 is emitted along a beam path 108 which is directed towards the metal workpiece 10 to be laser-processed. The pulsed laser beam 104 has a plurality of optical pulses 110 distributed along the beam path 108. The optical pulses 110 are emitted at a given repetition rate, i.e., the number of optical pulses 110 that are emitted each second. Each optical pulse 110 has a given pulse energy, i.e. the energy carried per pulse. The pulse energy and the repetition rate of the pulsed laser beam 104 can vary from one embodiment to another. For instance, in case of a singlemode pulsed laser beam, the pulse energy can vary between about 0.2 mJ/pulse and about 5 mJ/pulse, preferably between about 0.5 mJ/pulse and about 2 mJ/pulse and most preferably between about 0.5 mJ/pulse and about 1.5 mJ/pulse. The repetition rate can range between about 50 kHz and about 2000 kHz, preferably between about 100 kHz and about 1000 kHz and most preferably between about 200 kHz and about 1000 kHz. In case of a multimode pulsed laser beam, the pulse energy can vary between about 20 mJ/pulse and about 200 mJ/pulse, and preferably about 50 mJ/pulse and about 100 mJ/pulse. In this case, the repetition rate can range between about 1 kHz and about 100 kHz, and preferably between about 2 kHz and about 50 kHz. It is noted that the multimode pulsed laser beam can have a Gaussian intensity shape, a top-hat intensity shape or any other suitable intensity shape. In an experiment, a 500 W laser-processing system was used, with a repetition rate of 500 or 1000 kHz was found to be satisfactory.

As shown, the pulsed laser beam 104 is converging and therefore defines an in-focus region 112 and out-of-focus regions 114 on either side of the in-focus region 112. As the pulse energy is conserved along the beam path 108, the optical pulses 110 of the in-focus region 112 have the same pulse energy as the optical pulses 110 of the out-of-focus regions 114. However, as a beam dimension d of the pulsed laser beam 104 changes along the beam path 108, the optical pulses 110 will have different intensity, i.e., the optical energy delivered per area unit.

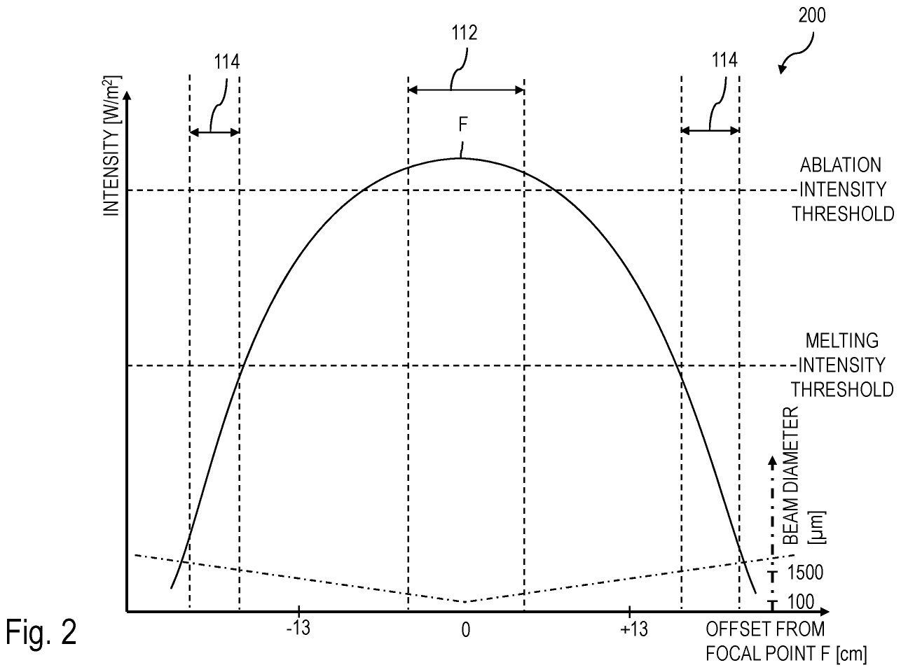

The relationship by which the intensity varies along the beam path 108 is best shown in the graph 200 of FIG. 2. As depicted, where the pulsed laser beam 104 is more converged (i.e., smaller beam diameter), the optical pulses will have a higher intensity. In contrast, where the pulsed laser beam 104 is less converged (i.e., larger beam diameter), the optical pulses will have a lower intensity as these optical pulses are a bit more spatially stretched. Accordingly, the intensity of the optical pulses is maximal at the focal point F of the beam path 108, and decreases on either side of the focal point F as the offset from the focal point F increases. As can be appreciated from the graph 200, the out-of-focus regions 114 of the pulsed laser beam 104 are defined as the region(s) extending along the beam path 108 where the optical pulses have an intensity below a melting intensity threshold of that metal. On the other hand, the in-focus region 112 of the pulsed laser beam 104 is defined as the region extending along the beam path 108 where the optical pulses have an intensity equal or greater than an ablation intensity threshold of the undesirable residue and/or of the metal of the metal workpiece.

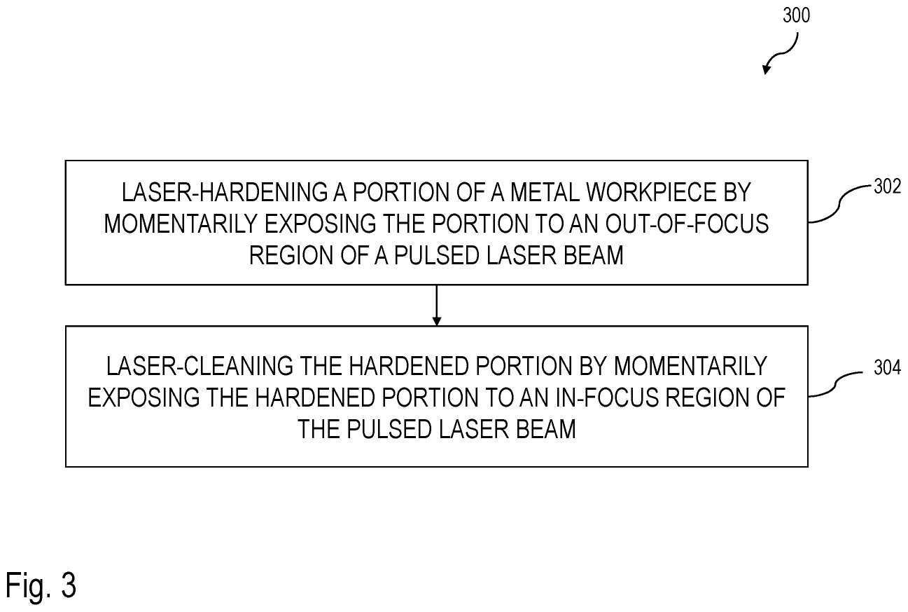

FIG. 3 shows a flow chart of a method 300 of laser-processing a metal workpiece. The method will be described with reference to the system 100 of FIG. 1 and to the graph 200 of FIG. 2 for ease of reading. As shown, the method 300 includes a step 302 of laser-hardening a portion 10a of the metal workpiece 10 by momentarily exposing the portion 10a of the workpiece 10 to the out-of-focus region 114 of the pulsed laser beam 104. The step 302 of laser-hardening is followed by a step 304 of laser-cleaning the hardened portion 10 of the metal workpiece 10 by momentarily exposing the hardened portion 10b of the metal workpiece 10 to the in-focus region 112 of the pulsed laser beam 104.

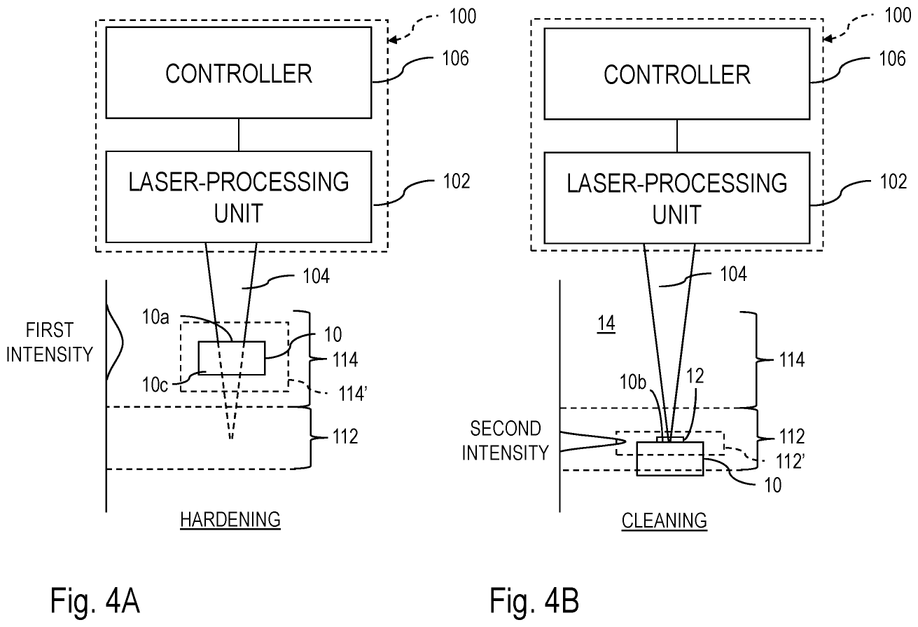

FIG. 4A shows a schematic illustration of the step 302 of laser-hardening. The momentarily exposition of the portion 10a of the metal workpiece 10 to the out-of-focus region 114 of the pulsed laser beam 104 delivers optical pulses having an intensity below the melting intensity threshold of the metal. Due to this exposure, the exposed portion 10a heats to a given temperature for a given period of time and quenches (i.e., rapidly cools down) after the momentary exposition. It is believed that the quenching can occur thanks to the surrounding, unheated portion 10c of the metal workpiece 10 which acts as a heat removing sink. After the step 302 of laser-hardening, the hardened portion 10b can be left with undesirable residue 12 thereon as is usual from any other hardening process.

Reference is now made to FIG. 4B which schematically illustrates the step 304 of laser-cleaning. As shown, the step 304 of laser-cleaning aims at cleaning the hardened portion 10b of the metal workpiece 10. More specifically, in this embodiment, the step 304 of laser-cleaning aims at removing the undesirable residue 12 off the hardened portion 10b of the metal workpiece 10. More specifically, the step 304 of laser-cleaning is performed by momentarily exposing the hardened portion 10b and/or the undesirable residue 12 to the in-focus region 112 of the pulsed laser beam 104, thereby delivering optical pulses having an intensity equal or greater than an ablation intensity threshold of the metal and/or of the residue 12. The so-exposed undesirable residue 12 is thus sublimated into the surrounding environment 14, leaving the hardened portion 10b clean from the undesirable residue 12. Region(s) of the metal workpiece 10 which lack(s) the undesirable residue 12 can be cleaned using the step 304 in some embodiments.

It is envisaged that either one or both of the steps 302 and 304 can comprise a relative movement between the metal workpiece 10 relative and the pulsed laser beam 104. The movement can be performed prior, during and/or after each one of the steps 302 and 304. Either one of the metal workpiece 10 or the pulsed laser beam 104 can be moved in this relative movement.

In some embodiments, the method 300 has a step of moving the metal workpiece 10 relative to the pulsed laser beam 104 prior to the steps 302 and 304. For instance, prior to step 302, the metal workpiece 10 can be moved so as to position the portion 10a within the out-of-focus region 114 of the pulsed laser beam 104. The metal workpiece 10 can then be moved, prior to step 304, so as to position the hardened portion 10b and/or the undesirable residue 12 within the in-focus region 112 of the pulsed laser beam 104. The pulsed laser beam 104 may remain stationary in such an embodiment.

In some other embodiments, the method 300 has a step of moving the pulsed laser beam 104 relative to the metal workpiece 10 prior to the steps 302 and 304. For instance, prior to the step 302, the pulsed laser beam 104 can be moved relatively to the metal workpiece 10 so that the out-of-focus region 114 of the pulsed laser beam 104 encompasses the portion 10a of the metal workpiece 10. Once laser-hardened, and prior to the step 304, the pulsed laser beam 104 can be moved again relatively to the metal workpiece 10 so that the in-focus region 112 of the pulsed laser beam 104 encompasses the hardened portion 10b and/or the undesirable residue 12 left on the hardened portion 10b of the metal workpiece 10. In this embodiment, the metal workpiece 10 may remain stationary during the steps 302 and 304.

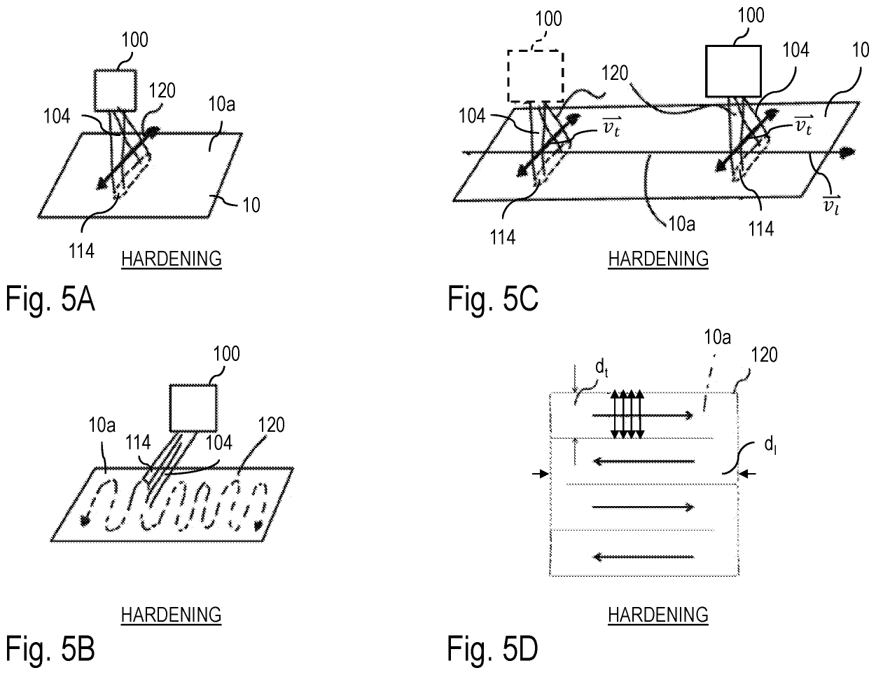

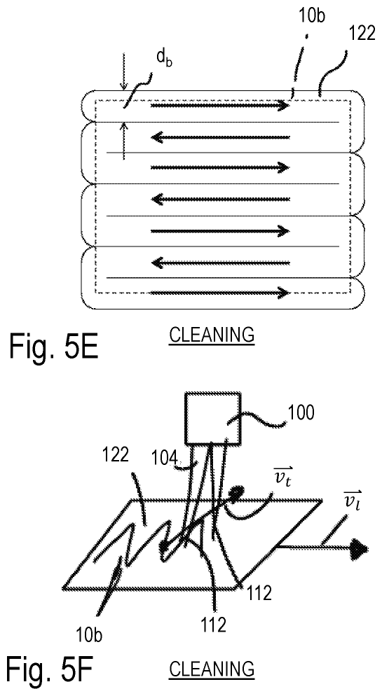

In some embodiments, the method 300 can have a step of moving the metal workpiece 10 relative to the pulsed laser beam 104 during the steps 302 and 304. For instance, when a larger portion 10a of the metal workpiece 10 is to be laser-processed, the movement of the metal workpiece 10 can be performed in accordance with a laser-hardening path during the step 302. Examples of laser-hardening paths 120 are shown in FIGS. 5A-5D.

FIG. 5A shows an example of a laser-hardening path 120. As depicted in this example, the out-of-focus region 114 of the pulsed laser beam 104 is moved in a sequence of back-and-forths on the same portion 10a of the metal workpiece 10. In this embodiment, the back-and-forths are performed at a scanning speed which can be up to 100 m/s. The number of back-and-forths required to heat the portion 10a to the desired temperature can vary from one embodiment to another. For instance, there can be 10, 100 or more back-and-forths on the portion 10a of the metal workpiece 10 to heat it sufficiently, in some embodiments. It is noted that the number of back-and-forths is dependent on a plurality of different parameters including, but not limited to, the intensity of the optical pulses along the out-of-focus region 114 of the pulsed laser beam 104, the length of the back-and-forths, the thermal inertia of the metal workpiece, the shape of the metal workpiece, and any other suitable properties which can have an impact on the absorption of heat by the metal workpiece.

FIG. 5B shows another example of a laser-hardening path 120. As shown in this embodiment, the out-of-focus region 114 of the pulsed laser beam 104 is moved in an arbitrary-shaped path on the portion 10a of the metal workpiece 10. In this embodiment, the scanning speed at which the out-of-focus region 114 is moved along the arbitrary-shaped path can be up to 100 m/s. The out-of-focus region 114 can be moved along the arbitrary-shaped path for a number of passes so as to heat the portion 10a to the desired temperature. Again, the number of back-and-forths is dependent on a plurality of different parameters including, but not limited to, the intensity of the optical pulses along the out-of-focus region 114 of the pulsed laser beam 104, the length of the back-and-forths, the thermal inertia of the metal workpiece, the shape of the arbitrary-shaped path and/or of the metal workpiece, any other suitable properties which can have an impact on the absorption of heat by the metal workpiece. In embodiments where the arbitrary-shaped path is linear, the laser-hardening path 120 of FIG. 5B can be similar to that of FIG. 5A.

FIG. 5C shows another example of a laser-hardening path 120. In this example, the out-of-focus region 114 of the pulsed laser beam 104 is moved in a sequence of transversal back-and-forths on the metal workpiece 10 at a given transversal speed vt while the out-of-focus region 114 of the pulsed laser beam 104 is moved longitudinally along the metal workpiece 10. In this example, the transversal speed vt is high compared to the longitudinal speed vl. For instance, the transversal speed can be up to 100 m/s whereas the longitudinal speed can be up to 200 mm/s. As can be appreciated, by transversally moving the pulsed laser beam 104 in a sequence of back-and-forths while longitudinally moving the pulsed laser beam 104, a satisfactory area of the metal workpiece 10 can be laser-hardened.

FIG. 5D shows an example of a laser-hardening path 120 comprising a number of the laser-hardening passes described with reference to FIG. 5C. Each laser-hardening pass has a transversal dimension dt and a longitudinal dimension dl, and thus an area of dt×dl. As shown, the portion 10a is laser-hardened by performing a given number N of adjacent laser-hardening passes, with the laser-hardening passes extending alongside each other. In this case, the laser-hardened portion has a total area of N×dt×dl.

Of course, the geometry of the region to laser-harden can dictate which laser-hardening path 120 is preferable. For instance, the laser-hardening path of FIG. 5A can be preferable to laser-harden a linear edge or ridge, the laser-hardening path of FIG. 5B can be preferable to laser-harden an arbitrary-shaped edge or ridge, and the laser-hardening paths of FIGS. 5C and 5D can be used to laser-harden larger areas. Other laser-hardening paths can be used. Although the above-described laser-hardening paths 120 are obtained by moving the pulsed laser beam 104, any relative movement between the pulsed laser beam 104 and the metal workpiece 10 can be performed. For instance, the pulsed laser beam 104 may be moved at the transversal speed vt while the metal workpiece 10 is moved at the longitudinal speed vl to obtain a laser-hardening path similar to that described in FIG. 5C.

During the step 304, the movement of the metal workpiece 10 can be performed in accordance with a laser-cleaning path. Examples of laser-cleaning paths 122 are shown in FIG. 5E-5F.

FIG. 5E shows an example of a laser-cleaning path 122. As shown in this embodiment, the in-focus region 112 of the pulsed laser beam is moved in a raster scan manner on the hardened portion 10b of the metal workpiece. The passes of the in-focus region of the pulsed laser beam can be spaced-apart from a beam dimension db, in this example.

FIG. 5F shows another example of a laser-cleaning path 122. Similarly to the laser-hardening path of FIG. 5C, the in-focus region 112 of the pulsed laser beam 104 can be moved in a sequence of back-and-forths at a transversal speed vt while being longitudinally moved at a longitudinal speed vl. Typically, the transversal speed vt is much greater than the longitudinal speed vl. For instance, the transversal speed can be up to 50 m/s whereas the longitudinal speed can be up to 5 m/s. By increasing the longitudinal speed vl relative to the transversal speed vt, the laser-cleaning path 122 can form a zig-zag shape on the hardening portion 10b of the metal workpiece. In some other embodiments, each transversal pass of the in-focus region 112 of the pulsed laser beam 104 can be oriented in a way that ensure that each transversal pass is parallel to previous and subsequent passes, regardless of the longitudinal speed vl.

Similarly, the method 300 can have a step of moving the pulsed laser beam 104 relative to the metal workpiece 10 during the steps 302 and 304. For instance, when a larger portion 10a of the metal workpiece 10 is to be laser-processed, the movement of the out-of-focus region 114 of the pulsed laser beam 104 can be performed in accordance with the laser-hardening paths 120 during the step 302 described with reference to FIG. 5C-D. Again, the movement of the pulsed laser beam 104 can be performed in accordance with the laser-cleaning paths 122 of FIGS. 5E-5F during the step 304 as well. In these embodiments, the metal workpiece 10 may remain stationary as well.

Referring back to FIGS. 4A and 4B, the metal workpiece 10 can be further moved while selectively activating and de-activating the pulsed laser beam 104 prior to and after said steps 302 and 304, respectively. For instance, while the pulsed laser beam 104 is de-activated, the metal workpiece 10 can be moved so as to position the portion 10a within an out-of-focus window 114′ corresponding to where the out-of-focus region 114 of the pulsed laser beam 104 is expected to appear upon activation of the pulsed laser beam 104. Once so-positioned, the pulsed laser beam 104 can be activated thereby performing the step 302 of laser-hardening. After de-activation of the pulsed laser beam 104, and while the pulsed laser beam 104 remains de-activated, the metal workpiece 10 can be moved so as to position the hardened portion 10b and/or the undesirable residue 12 within an in-focus window 112′ corresponding to where the in-focus region 112 of the pulsed laser beam 104 is expected to appear upon activation of the pulsed laser beam 104. Once satisfactorily positioned, the pulsed laser beam 104 can be activated thereby performing the step 304 of laser-cleaning. In this embodiment, the pulsed laser beam 104 may remain stationary with momentary activation(s) and de-activation(s) of the pulsed laser beam 104. In this specific example, the activation(s) and de-activation(s) of the pulsed laser beam can be performed using a switch or shutter made integral to the laser-processing unit 102.

It will be understood that the above-described embodiments are meant to be exemplary only. For instance, both the metal workpiece 10 and the pulsed laser beam 104 may be moved simultaneously prior to, during and/or after either one or both of the steps 302 and 304.

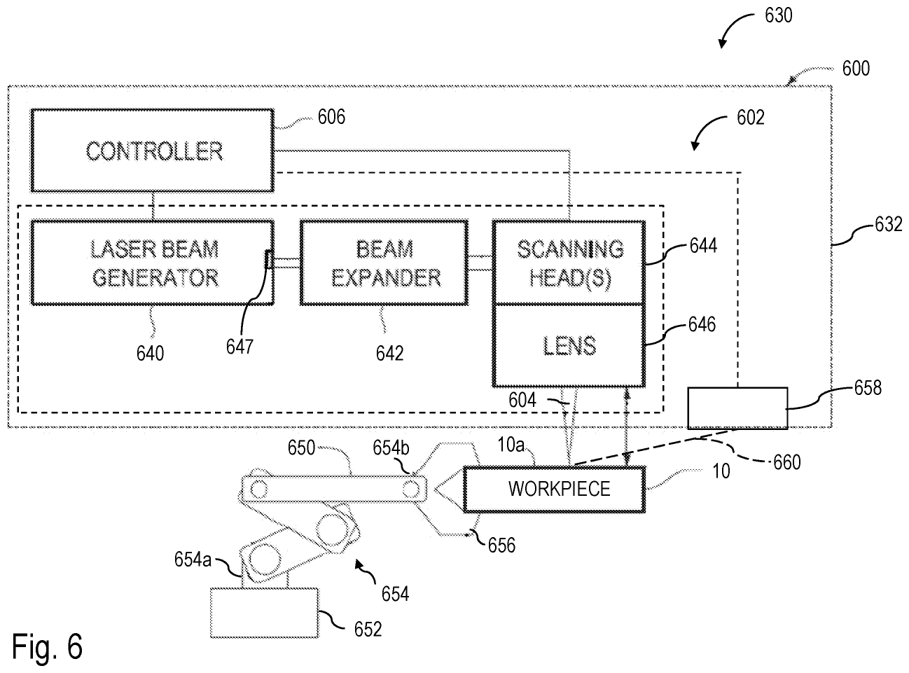

Reference is now made to FIG. 6, showing an example of a hardening and cleaning station 630 which can be disposed along a manufacturing line for laser-processing metal workpieces 10. As shown, the hardening and cleaning station 630 has a frame 632 located proximate the manufacturing line where the metal workpieces 10 are to be conveyed. The hardening and cleaning station 630 has a system 600 for laser-processing metal workpieces 10 such as the system 100 described above with reference to FIG. 1. As shown in this embodiment, the system 600 has a laser-processing unit 602 which is communicatively coupled to a controller 606. More specifically, the laser-processing unit 602 includes a laser beam generator 640 (e.g., such as a fiber laser source), an optional beam expander 642, scanning head(s) 644 and a focal lens 646. A beam shutter 647 is also provided to selectively activate and de-activate the pulsed laser-beam 604. The beam shutter can be electronically controlled in some embodiments, e.g., by controlling the power supplied to the laser beam generator 640. In this embodiment, the scanning head(s) 644 and the focal lens 646 can be used collectively to move the pulsed laser beam 604 relative to the metal workpiece 10 prior to, during and/or after the steps of laser-hardening and laser-cleaning.

Additionally, in this example, the hardening and cleaning station 630 has a robot arm 650 mounted to the frame 632 which can move the metal workpiece during laser-processing. In this embodiment, both the metal workpiece 10 and the pulsed laser beam 604 can be moved as desired during the laser-processing.

As discussed above, the station 603 is configured to laser-hardening a portion 10a of the metal workpiece 10. In this laser-hardening step, the station 630 momentarily exposes the portion 10a to an out-of-focus region of the pulsed laser beam 604. This causes heating of the exposed portion 10a to a given temperature and quenching thereafter. The out-of-focus region of the pulsed laser beam 604 used in the laser-hardening step can have a first beam dimension and can be moved at a first speed on the portion 10a of the metal workpiece 10. The first beam dimension and the first speed are configured to deliver a first amount of energy to the portion 10a of the metal workpiece 10.

In some embodiments, after the step of laser-hardening, the station 630 is configured to perform another step of laser-processing on the portion 10a of the metal workpiece 10. This additional step is referred to herein as a laser-tempering step. In this laser-tempering step, the station 630 is configured to yet again momentarily expose the hardened portion 10a to an out-of-focus region of the pulsed laser beam 604. This causes heating of the hardened portion 10a to a given temperature and quenching of it thereafter, thereby slightly reducing the hardness and flushing out any internal constraints that may have been induced by the laser-hardening step. The nominal power of the pulsed laser beam can be modified for the laser-tempering step. For instance, the nominal power of the pulsed laser beam can be lower in the laser-tempering step than in the laser-hardening step. The out-of-focus region of the pulsed laser beam 604 of this step can have a second beam dimension and can be moved at a second speed on the portion 10a of the metal workpiece 10. The second beam dimension and the second speed are configured to deliver a second amount of energy per area unit to the portion 10a of the metal workpiece 10. Typically, the second amount of energy delivered to the metal workpiece 10 in the laser-tempering step is smaller than the first amount of energy per area unit delivered to the metal workpiece 10 in the laser-hardening step. The first and second beam dimensions can have be similar for both the laser-hardening and the laser-tempering steps in some embodiments. In these embodiments, the second speed may be greater than the first speed thereby delivering a lesser amount of energy per area unit in the laser-tempering step than in the laser-hardening step. However, in some other embodiments, the first and second beam dimensions can differ. In some preferred embodiments, it was found useful to use, in the laser-tempering step, a second beam dimension that is larger than the first beam dimension and to move it on the portion 10a at the first speed, i.e., the same speed used in the laser-hardening step.

As discussed above, the station 630 is configured to laser-clean the hardened portion 10a by momentarily exposing the hardened portion 10a to an in-focus region of the pulsed laser beam 604, thereby cleaning the hardened portion of any undesirable matter. The in-focus region of the pulsed laser beam 604 used in the laser-cleaning step can have a third beam dimension and can be moved at a third speed on the portion 10a of the metal workpiece 10. Typically, the third beam dimension is well smaller than the first and second beam dimensions. As such, the first beam dimension and the first speed are generally configured to deliver a third amount of energy per area unit which is well above the first and second amounts of energy per area unit to the portion 10a.

In some embodiments, the station 630 is configured to laser-mark an identifier on the laser-hardened and laser-cleaned portion of the metal workpiece 10. The identifier can be a serial number, a QR code, or any other suitable type of identifier. By laser-marking an identifier on the metal workpiece 10, the metal workpieces 10 laser-processed by the station 630, or other stations, can be tracked. It is intended that the laser-tempering step and the laser-marking steps are only optional as either one of them can be omitted in at least some embodiments.

In some embodiments, the scanning head(s) 644 and/or the focal lens 646 can be omitted; the relative movement between the metal workpiece 10 and the pulsed laser beam 604 thereby relying solely on the robot arm 650. In this example, the robot arm 650 has a base 652, an articulated arm 654 having an end 654a fixedly mounted to the base 652 and an opposite free end 654b. A gripping member or otherwise holding member 656 can be articulatably mounted to the free end 654b for moving the metal workpiece 10 as desired during the laser-processing.

It is appreciated in this embodiment that the system 600 includes a temperature sensor 658 which measures the temperature of the portion 10a of the metal workpiece 10 over time, and especially during the laser-hardening step in which the portion 10a is momentarily exposed to the out-of-focus region of the pulsed laser beam 604. In such an embodiment, the temperature sensor 658 is communicatively coupled to the controller 606. Accordingly, when the monitored temperature of the portion 10a of the metal workpiece 10 exceeds a given temperature threshold, the momentary exposition is stopped, thereby allowing the heated portion 10a of the metal workpiece 10 to quench by itself. The temperature sensor 658 can be provided in the form of a pyrometer which measures the temperature of the portion 10a in a non-contact, remote fashion. In such embodiments, it can be convenient to move the line of sight 660 of the temperature sensor 658 so as to follow the movement of the pulsed laser beam 604. The step of laser-hardening can include a control loop comprising i) momentarily exposing the portion 10a of the metal workpiece 10 to the out-of-focus region of the pulsed laser beam 604, ii) measuring the temperature of the heated portion 10a, iii) comparing the measured temperature to a temperature threshold, and v) repeating the steps i), ii) and iii) until the measured temperature of the heated-portion 10 reaches and/or exceeds the temperature threshold. In this control loop, it is envisaged that at each iteration of the step ii) can include moving the out-of-focus region of the pulsed laser beam 604 according to a given laser-hardening path. The laser-hardening path can even be modified on the go so as to avoid any over-exposition of a sufficiently heated region of the metal workpiece 10. In some embodiments, the temperature sensor 658 can be used in the laser-tempering step as well. In these embodiments, the step of laser-tempering can include a control loop as well. The laser-tempering step can be deemed to be satisfactory when the measured temperature reaches the temperature threshold. It is noted that the temperature thresholds may differ for the laser-hardening and laser-tempering steps. When the measured temperatures correspond to their corresponding temperature threshold, the hardness of the corresponding portion 10a of the metal workpiece 10 can be deemed to be satisfactory, e.g., within a desired hardness range. The closed loop discussed above can be done in real-time during the laser-hardening and/or laser-tempering steps. In such embodiments, the controller can be configured to modify the laser power of the pulsed laser beam based on the measured temperature value. For instance, if the temperature sensor detects that the measured temperature value is below the threshold, the laser power can be slightly increased until the threshold is met or exceeded.

In some embodiments, the temperature sensor can be used to monitor the temperature of the portion 10a during the laser-hardening step and the laser-tempering step on the portion 10s of the metal workpiece 10. The monitored temperature can then be provided in the form of temperature profile(s) which can be stored on an accessible memory system and/or transmitted to an external network. In some embodiments, the temperature profiles for a given metal workpiece can be compared to reference temperature profiles for that given metal workpiece. When a monitored temperature profile does not satisfactorily compare to the corresponding reference profile, an alert can be generated and the portion 10a of the metal workpiece 10 may be laser-processed again to apply corrective measures, or rejected, depending on the embodiment.

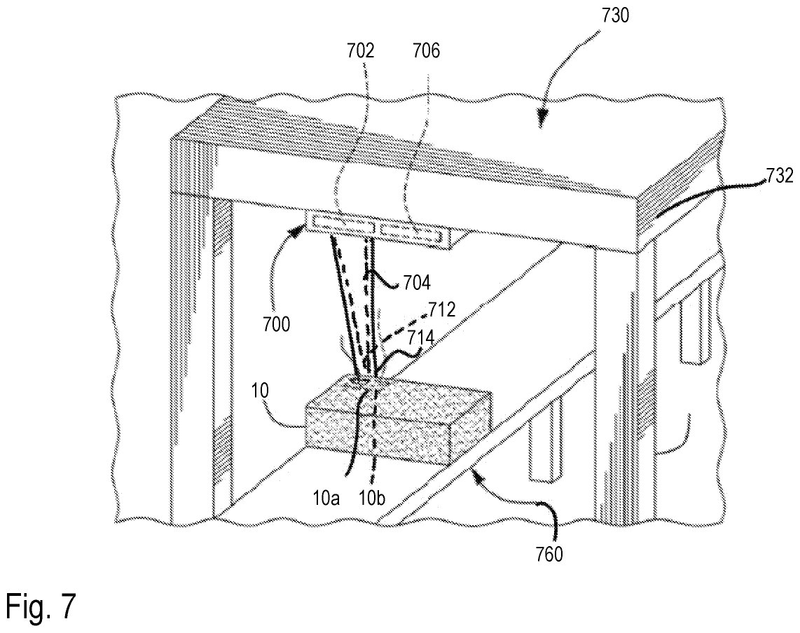

FIG. 7 shows another type of a hardening and cleaning station 730 which can be disposed along a manufacturing line for laser-processing metal workpieces 10. As shown, the hardening and cleaning station 730 has a frame 732 located proximate the manufacturing line where the metal workpieces 10 are to be conveyed. The hardening and cleaning station 730 has a system 700 for laser-processing metal workpieces 10. As shown in this embodiment, the system 700 has a laser-processing unit 702 which is communicatively coupled to a controller 706. More specifically, in this example, the laser-processing unit 702 can include a laser beam generator, a beam expander, scanning head(s) and a variable focal lens. In this embodiment, the scanning head(s) and the variable focal lens are used collectively to move the pulsed laser beam 704 relative to the metal workpiece 10 in a way that exposes the out-of-focus region 714 of the pulsed laser beam 704 to the portion 10a of the metal workpiece 10 during the laser-hardening step, and that exposes the in-focus region 712 of the pulsed laser beam 704 to the hardened portion 10b of the metal workpiece 10 during the laser-cleaning step. As shown, the hardening and cleaning station 730 is positioned above a conveyor 760 of the manufacturing line such that a series of metal workpieces 10 can be successively conveyed across a laser-processing window of the laser-processing unit 702. The system 700 can have a temperature sensor to monitor the temperature of the portion 10a of the metal workpiece as it is heated by the out-of-focus region 714 of the pulsed laser beam 704.

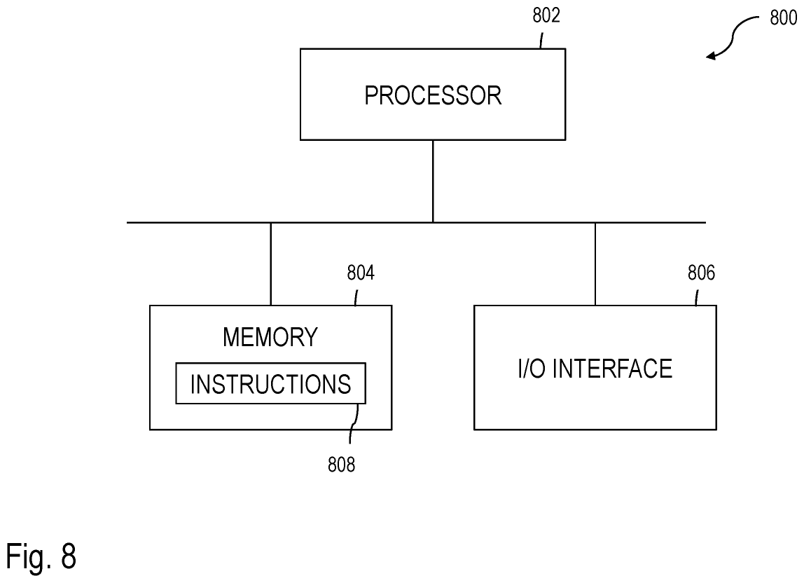

The controllers 106, 606 and 706 described above can be provided as a combination of hardware and software components. The hardware components can be implemented in the form of a computing device 800, an example of which is described with reference to FIG. 8. Moreover, the software components can be implemented in the form of a software application (not shown).

Referring to FIG. 8, the computing device 800 can have a processor 802, a memory 804, and I/O interface 806. Instructions 808 for performing the steps of laser-hardening and laser-cleaning can be stored on the memory 804 and accessible by the processor 802.

The processor 802 can be, for example, a general-purpose microprocessor or microcontroller, a Programmable Logic Controller (PLC), a digital signal processing (DSP) processor, an integrated circuit, a field programmable gate array (FPGA), a reconfigurable processor, a programmable read-only memory (PROM), or any combination thereof.

The memory 804 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 806 enables the computing device 800 to interconnect with one or more input devices, such as position sensor(s) of the robot arm, vision camera, positions sensor(s) of the conveyor, or with one or more output devices such as a display, a database or a remote network.

Each I/O interface 806 enables the computing device 800 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

In some embodiments, the software application is stored on the memory 804 and accessible by the processor 802 of the computing device 800. The computing device 800 and the software application described above are meant to be examples only. Other suitable embodiments of the controller can also be provided, as it will be apparent to the skilled reader.

### EXAMPLE

### Laser-Hardening 8660 Steel Workpieces

Using a pulsed laser beam with optical pulses of temporal durations in the nanosecond range (e.g., 100 ns) and average power of 500 W, 8660 steel workpieces, including a 8660 steel longnose plier and a 8660 steel cutter, were laser-hardened and then laser-cleaned according to the method(s) described herein. In this embodiment, the momentary exposure between the pulsed laser beam and the 8660 steel workpieces spanned between about 600 ms and about 1000 ms, which could heat the exposed portions of the 8660 steel workpieces to about 1200° C. to about 1350° C. In this example, the requirements on hardness were 60-64 HDC (750-900 HV) over a depth of about 1000 μm. Several combinations of parameters were tested to determine satisfactory parameters. For instance, the scanning speed at which the pulsed laser beam was moved in the laser-hardening step varied between about 1.5 mm/s to about 3.5 mm/s; the exposition time during which the out-of-focus region of the pulsed laser beam interacted with the portion of the 8660 steel workpiece varied between about 430 ms and about 1000 ms; the power was varied between 45% of 500 W and 85% of 500 W; the irradiance was varied between 2.9 W/mm² and about 6.0 W/mm²; which allowed the heated portion of the 8660 steel workpiece to reach between about 900° C. and about 1350° C. In a given example, the focal point F of the pulsed laser beam was spaced-apart from the portion of the 8660 steel workpiece by about 13 cm, with the focal point F lying above the 8660 steel workpiece, the repetition rate of the pulsed laser beam was 1000 kHz and the speed at which the out-of-focus region was scanned perpendicular to the laser-hardening path was 1000 mm/s. For the 8660 longnose plier, a combination of parameter that was found to obtain satisfactory hardness includes: scanning speed of 2.5 mm/s (which gives an effective exposition time of 600 ms), power set to 85% of 500 W for an irradiance of 6.0 W/mm², to heat up the exposed portion to 1350° C. For the 8660 longnose plier, another combination of parameter that was found to obtain satisfactory hardness includes: scanning speed of 1.5 mm/s for an exposition time of 1000 ms, power set to 65% of 500 W for an irradiance of 4.1 W/mm², to heat up the exposed portion to 1300° C. For the 8660 steel cutter, a combination of parameter that was found to obtain satisfactory hardness includes: scanning speed of 2.5 mm/s (which gives an effective exposition time of 600 ms), power set to 65% of 500 W for an irradiance of 5.8 W/mm², to heat up the exposed portion to 1300° C. For laser-tempering the 8660 steel workpiece, the temperature may be brought up to around 200-500 F, preferably about 350 F.

Still in this example, the total exposure time between the in-focus region of the pulsed laser beam and the 8660 steel workpieces spanned between about 6 s and 26 s while the power was varied between 100 W and 500 W. In some embodiments, a metal workpiece laser-processed according to the method described herein has been cut across the depth to allow the measurement of the hardness as a function of the depth of the metal workpiece. For instance, the following table shows different depths at which the hardness measurements were made, and the hardness measurements.

TABLE 1
Hardness as function of depth martensitic transition
can be observed between about 40 and 50 thousands
of an inch in this specific embodiment.

| Distance | Hardness |
|---|---|
| (inch) | (RC) |
| 0.004 | 63 |
| 0.007 | 64 |
| 0.010 | 64 |
| 0.020 | 64 |
| 0.030 | 63 |
| 0.040 | 60 |
| 0.050 | 38 |
| 0.060 | 39 |

As such, it was confirmed that the method described herein in fact increase the hardness of the processed metal. As can be understood, the examples described above and illustrated are intended to be exemplary only. The scope is indicated by the appended claims.

What is claimed is:

1. A method of laser-processing a metal workpiece, the method comprising:
laser-hardening a portion of the metal workpiece by momentarily exposing said portion to an out-of-focus region of a pulsed laser beam, the exposed portion heating to a given temperature and quenching thereafter, the sequence of said heating and said quenching thereby hardening said exposed portion; and
laser-cleaning the hardened portion by momentarily exposing said hardened portion to an in-focus region of said pulsed laser beam, thereby cleaning said hardened portion.

2. The method of claim 1 wherein the pulsed laser beam has a plurality of optical pulses having a first intensity within the out-of-focus region and a second intensity within the in-focus region, the first intensity being below a melting intensity threshold of said metal and below the second intensity.

3. The method of claim 2 wherein the second intensity is greater than the melting intensity threshold and equal to or greater than an ablation intensity threshold of said metal.

4. The method of claim 3 wherein the ablation intensity threshold is indicative of an intensity at which said metal ablates.

5. The method of claim 3 wherein said sequence of said heating and said quenching leaves residue on said hardened portion of said metal workpiece, the ablation intensity threshold being of an intensity at which the residue ablates.

6. The method of claim 1 further comprising, between the step of laser-hardening and the step of laser-cleaning, performing a relative movement between said metal workpiece and said pulsed laser beam.

7. The method of claim 6 wherein said relative movement includes moving said portion of said metal workpiece from within the out-of-focus region of the pulsed laser beam to the in-focus region of the pulsed laser beam.

8. The method of claim 6 wherein said relative movement includes moving said pulsed laser beam from the hardened portion being exposed to the out-of-focus region to the hardened portion being exposed to the in-focus region of the pulsed laser beam.

9. The method of claim 1 further comprising selectively de-activating said pulsed laser beam after said step of laser-hardening and activating said pulsed laser beam prior to said step of laser-cleaning.

10. The method of claim 1 wherein said step of laser-hardening comprises performing a relative movement between said metal workpiece and said pulsed laser beam, said relative movement being in accordance with a laser-hardening path.

11. The method of claim 1 wherein said step of laser-cleaning comprises performing a relative movement between said metal workpiece and said pulsed laser beam, said relative movement being in accordance with a laser-cleaning path.

12. The method of claim 1 wherein said laser-hardening comprises measuring a temperature of said heated portion, and stopping said momentary exposure upon determining that said measured temperature is above a temperature threshold.

13. The method of claim 1 wherein said laser-hardening delivers a first amount of energy per area unit to said portion of said metal workpiece, the method further comprising, after said laser-hardening, laser-tempering said metal workpiece by exposing said hardened portion to an out-of-focus region of said pulsed laser beam, said laser-hardening delivering, to said hardened portion, a second amount of energy per area unit being lower than said first amount of energy per area unit.

14. The method of claim 1 further comprising laser-marking an identifier on the laser-hardened and laser-cleaned portion of said metal workpiece.

15. A system for laser-processing a metal workpiece along a manufacturing line, the system comprising:
a hardening and cleaning station having a frame located proximate said manufacturing line where said metal workpiece is conveyed;
a laser-processing unit mounted to said frame and emitting a pulsed laser beam;
and
a controller communicatively coupled to the laser-processing unit, the controller having a processor and a memory having stored thereon instructions that when executed by the processor perform the steps of:
laser-hardening a portion of the metal workpiece by momentarily exposing said portion to an out-of-focus region of a pulsed laser beam, the exposed portion heating to a given temperature and quenching thereafter, the sequence of said heating and said quenching thereby hardening said exposed portion; and
laser-cleaning the hardened portion by momentarily exposing said hardened portion to an in-focus region of said pulsed laser beam, thereby cleaning said hardened portion.

16. The system of claim 15 wherein said laser-processing unit comprises at least a scanning head moving the pulsed laser beam between said step of laser-hardening and said step of laser-cleaning.

17. The system of claim 15 further comprising a robot arm mounted to said frame and moving said metal workpiece at least between said step of laser-hardening and said step of laser-cleaning.

18. The system of claim 15 wherein the controller selectively de-activates said pulsed laser beam after said step of laser-hardening and re-activates said pulsed laser beam prior to said step of laser-cleaning.

19. The system of claim 15 further comprising a temperature sensor monitoring a temperature of said heated portion of said metal workpiece during said step of laser-hardening.

20. The system of claim 19 wherein said controller modifies a laser power of said pulsed laser beam based on the monitored temperature.

21. The system of claim 15 further comprising a variable focal lens used at least partially to move said pulsed laser beam relative to said metal workpiece in a way that exposes said out-of-focus region of said pulsed laser beam to said portion of said metal workpiece during said step of laser-hardening, and that exposes said in-focus region of said pulsed laser beam to said hardened portion of said metal workpiece during said step of laser-cleaning.
